(19) United States
(12) Patent Application Publication
(10) Pub. No.: US 2025/0110567 A1
(43) Pub. Date: Apr. 3, 2025

(54) POSE PREDICTOR FOR MOVING PLATFORM

(71) Applicant: Apple Inc., Cupertino, CA (US)

(72) Inventors: Stergios Roumeliotis, Los Altos Hills, CA (US); Yichao Zhou, Bellevue, WA (US); Abdelhamid Dine, Santa Clara, CA (US); Oleg Naroditsky, San Francisco, CA (US)

(21) Appl. No.: 18/816,517

(22) Filed: Aug. 27, 2024

Related U.S. Application Data
(60) Provisional application No. 63/541,143, filed on Sep. 28, 2023.

(51) Int. Cl. G06F 3/01; G01C 21/16; G06T 15/20

(52) U.S. Cl. CPC G06F 3/017; G01C 21/166; G06T 15/20

(57) ABSTRACT

Various implementations disclosed herein include devices, systems, and methods that isolates movement of a user from movement of a platform moving with the user. For example, a process may obtain motion sensor data corresponding to an electronic device while the electronic device is located on a moving platform. The motion sensor data includes a measurement representing a combined motion of a user and the moving platform. The process may further extract from the motion sensor data, user motion data representing motion of the user. The process may further allocate the extracted user motion data as input for user motion analysis.

### CROSS-REFERENCE TO RELATED APPLICATIONS

This application claims the benefit of U.S. Provisional Application Ser. No. 63/541,143 filed Sep. 28, 2023, which is incorporated herein in its entirety.

### TECHNICAL FIELD

The present disclosure generally relates to systems, methods, and devices that present motion adjusted rendered content viewed via electronic devices, such as head-mounted devices (HMDs).

### BACKGROUND

Existing techniques for presenting content via electronic devices may not accurately account for movement-based attributes.

### SUMMARY

Various implementations disclosed herein include devices, systems, and methods that render content, such as virtual content, within an extended reality (XR) environment. The content may be rendered via a device being operated by a user on a moving platform such as, inter alia, an aircraft, an elevator, an automobile, a train, a boat or ship, etc. The content may be rendered with respect to a viewpoint corresponding to a predicted future device pose corresponding to user motion without including motion of the moving platform. Motion of the user and motion of the platform may be distinguished by analyzing motion data to distinguish different movement patterns and characteristics exhibited by the user from moving platforms and characteristics associated with movement of the moving platform. For example, motion of moving platform such as an airplane may follow a constant and low-frequency pattern, characterized by movements such as, inter alia, ascending, descending, and/or maintaining a specific velocity. Likewise, motion of a user may include smaller, more intricate movements such as head tilts, rotations, and translations, etc.

In some implementations, a predicted future device pose may be associated with a six degrees of freedom (6DOF) position or orientation of a device. The predicted future device pose may be determined by inputting previously-obtained device pose data and currently-obtained inertial measurement unit (IMU) data into a machine learning model. The IMU data comprises a measurement of the combined motion of the user and the moving platform retrieved via, inter alia, a motion sensor.

Some implementations include training a machine learning model(s) (e.g., an extraction module, a prediction module, etc.) using movement patterns of moving platforms (e.g., an airplane, an elevator, a car, etc.) and human motion movement patterns to distinguish between motion of the platform and motion of the user holding or wearing the device. The machine learning model may be configured to receive IMU data (containing both user motion data and platform motion data) and extract only user motion data for output. Likewise, the machine learning model may be configured to receive IMU data (containing both user motion data and platform motion data) and extract the user motion data for output via a first output of the machine learning model and extract the platform motion data for output via a second output of the machine learning model.

The machine learning model (e.g., an extraction module) may be further configured to extract user motion information from IMU data (containing both user motion information and platform motion information) for input into an additional machine learning model (e.g., a prediction module) to analyze the user motion information to extrapolate into the future thereby providing predicted device poses at specified time intervals. Likewise, an associated rendering process subsequently utilizes the predicted device poses rather than utilizing a current device pose thereby enabling improved synchronization between a user's perception and rendered surroundings.

Some implementations utilize machine learning training that involves a loss function configured to incorporate accuracy and smoothness penalties. An accuracy component of the machine learning model may be configured to minimize an error between a predicted device pose and a ground truth device pose. Likewise, a smoothness component of the machine learning model may be configured to promote stable and smooth transitions between consecutive predicted device poses. Maintaining a balance between accuracy and smoothness may enable the machine learning model to generate accurate and coherent predicted future device poses over time.

Some implementations utilize sensors such as doppler radar sensors or light detection and ranging (LIDAR) sensors to provide velocity information for the machine learning model. Some implementations may enable sensors such as ultra-wideband (UWB), Wi-Fi, lasers, and/or cell-based sensors to provide global positioning information to assist with localization attributes.

In some implementations, an electronic device has a processor (e.g., one or more processors) that executes instructions stored in a non-transitory computer-readable medium to perform a method. The method performs one or more steps or processes. In some implementations, the electronic device obtains, from a motion sensor, motion sensor data corresponding to the electronic device while the electronic device is located on a moving platform. Pose data corresponding to a prior device pose of the electronic device may be obtained and a future device pose may be predicted based on inputting the prior device pose and the motion sensor data into a machine learning model. The machine learning model may predict the future device pose relative to the moving platform such that a pose change from the prior device pose to the predicted future device pose excludes motion of the moving platform. Virtual content may be rendered, via the electronic device, within a 3D environment based on a viewpoint within the 3D environment. The viewpoint may be determined based on the predicted future device pose.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in motion in accordance with some implementations.

FIG. 2 illustrates a system enabled to render content within an extended reality (XR) environment via a device being operated by a user on a moving platform, in accordance with some implementations.

FIG. 3 illustrates a timeline associated with a machine learning-based device pose predictor process, in accordance with some implementations.

FIG. 4 illustrates a process representing predicted device poses with respect to virtual odometry input, in accordance with some implementations.

FIG. 5 illustrates a view of a system comprising a recurrent neural network (RNN) configured to analyze input comprising sequential time series data, in accordance with some implementations.

FIG. 6A is a flowchart representation of an exemplary method that separates human motion from platform motion, in accordance with some implementations.

FIG. 6B is a flowchart representation of an exemplary method that renders content within an XR environment via a device being operated by a user on a moving platform, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

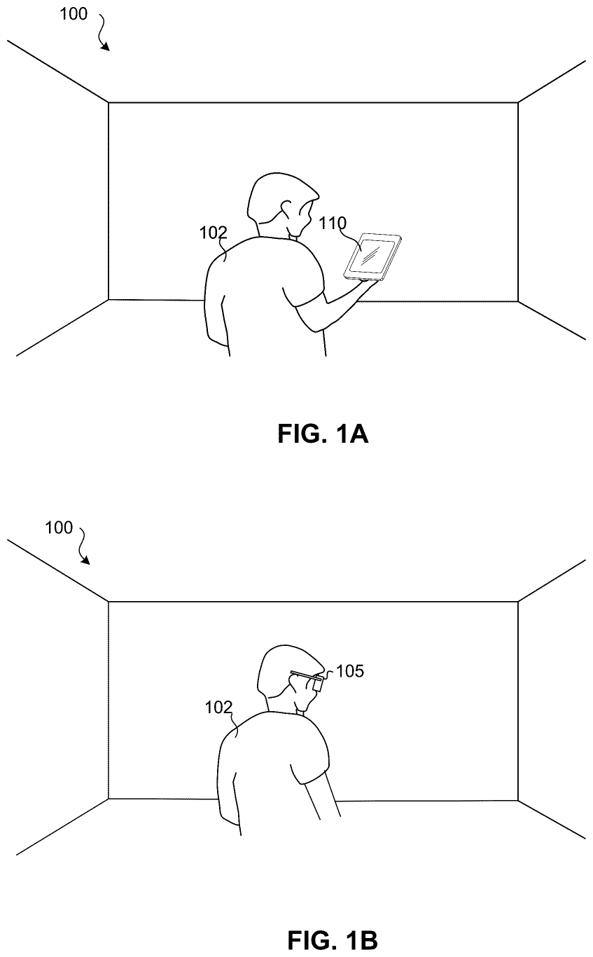

FIGS. 1A-B illustrate exemplary electronic devices 105 and 110 operating in a physical environment (or structure) 100 in motion. In the example of FIGS. 1A-B, the physical environment 100 in motion is an elevator. Alternatively, the physical environment 100 in motion may be any type of moving platform comprising a structure surrounding a user 102 using or wearing electronic device 105 and/or 110. For example, the physical environment 100 in motion may be, inter alia, an aircraft, an automobile, a train, a boat or ship, etc. The electronic devices 105 and 110 may include one or more cameras, microphones, depth sensors, or other sensors that can be used to capture information about and evaluate the physical environment 100 in motion and the objects within it, as well as information about the user 102 of electronic devices 105 and 110. The information about the physical environment 100 in motion and/or user 102 may be used to provide visual and audio content and/or to identify the current location of the physical environment 100 in motion and/or the location of the user within the physical environment 100 in motion.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100 in motion.

In some implementations, an HMD (e.g., device 105) may be configured to render content within the physical environment 100 (e.g., moving platform) in motion with respect to a viewpoint corresponding to a predicted future device pose of user 102 motion without including motion of the physical environment 100. In some implementations, motion of user 102 and motion of physical environment 100 may be distinguished by analyzing different movement patterns executed by user 102 and by the physical environment 100. For example, motion of the physical environment 100 such as an elevator may follow a constant and low-frequency pattern, characterized by movements such as, inter alia, ascending, descending, or maintaining a specific velocity. Likewise, motion of user 102 may include smaller, more intricate movements.

In some implementations, a machine learning model may be configured to receive IMU data (containing both user motion data and platform motion data) and extract only the user motion data for output. In some implementations, the extracted user motion data may be optionally used by an additional machine learning model for, inter alia, generating a predicted future device pose.

In some implementations, a predicted future device pose is determined by inputting previously obtained device poses (e.g., two) and currently obtained IMU data into a machine learning model. The machine learning model may be trained using movement patterns of moving platforms (e.g., an airplane, an elevator, a car, etc.) and human motion movement patterns to distinguish between physical environment 100 motion and user 102 motion. For example, the machine learning model may be trained using real data collected from moving platforms, such as elevators, to learn to separate and filter differing relevant motions for improved accuracy and performance. With respect to training the machine learning model, a loss function may be used to optimize the machine learning model by computing a distance between a current output and an expected output of the machine learning model. For example, a loss function may analyze an accuracy and a smoothness of extracted user motion data and/or device pose predictions. Analyzing an accuracy and smoothness of device pose predictions may include enabling a loss function to incorporate accuracy and smoothness penalties to optimize the machine learning model. An accuracy component of the machine learning model may be configured to minimize an error between a predicted device pose and a ground truth device pose. Likewise, a smoothness component of the machine learning model may be configured to promote stable and smooth transitions between consecutive predicted device poses.

Some implementations provide two machine learning models. For example, a first machine learning model (e.g., an extraction module) may be enabled to output extracted user motion data and a second machine learning model (e.g., a prediction module) may be enabled to utilize the extracted user motion data as input to generate, for example, predicted poses. Alternatively, the second machine learning model may be enabled to utilize the extracted user motion data as input to generate any type of associated operational data.

A machine learning model may be configured to extract user 102 motion information from the IMU data and analyze the user 102 motion information to extrapolate into the future thereby providing predicted device poses at specified time intervals. Subsequently, an associated rendering process is enabled to utilize predicted device poses rather than utilizing a current device pose thereby enabling improved synchronization between a user's perception and rendered surroundings.

The machine learning model may utilize additional data from sensors such as doppler radar sensors or light detection and ranging (LIDAR) sensors to provide velocity information for the machine learning model. Additionally, the machine learning model may utilize additional data from sensors such as ultra-wideband (UWB), Wi-Fi, lasers, cell-based sensors to provide global positioning information to assist with localization attributes.

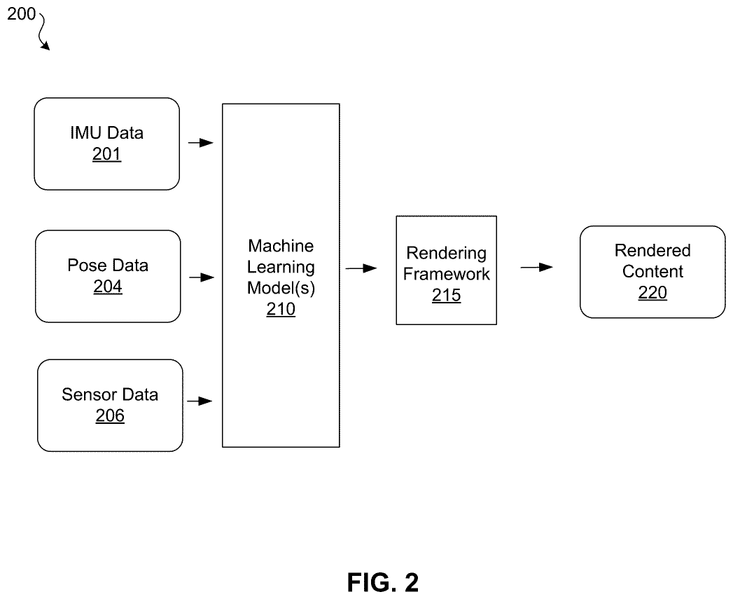

FIG. 2 illustrates a system 200 enabled to render content within an extended reality (XR) environment via a device being operated by a user on a moving platform such an elevator or airplane, in accordance with some implementations. System 200 comprises a machine learning model(s) 210 and a rendering framework 215 configured to analyze and modify motion data such as IMU data 201, prior pose data 204, and sensor data 206 when a user is on a moving platform. However, when a user is on a moving platform, an IMU sensor may be configured to measure a combined motion of the user and the moving platform. Therefore, machine learning model(s) 210 is trained to distinguish between motion of the platform and motion of the user thereby allowing for proper integration of IMU data 201 to enable device pose predictions for accurate content rendering. For example, machine learning model(s) 210 may be configured to extract relevant motion information associated with only motion of the user from IMU data comprising a measurement representing a combined motion of the user and a moving platform. In some implementations, the extracted relevant motion information associated only with motion of the user may be utilized to extrapolate into the future, thereby providing predicted device pose positions at specific times. A rendering process utilizes the predicted device pose positions rather than requesting a current device pose position thereby enabling accurate synchronization between the user's perception and rendered surroundings for improved content rendering and overall user experience.

Distinguishing between motion of the user and motion of the platform may include analyzing different movement patterns exhibited by the user and the moving platform. Capturing differences between motion of the user and motion of the platform may comprise enabling a filtering technique for filtering out motion of the platform and highlighting motion of the user.

In some implementations, machine learning model(s) 210 obtains an input sequence comprising IMU data 201 (comprising measurements) that includes angular velocity and acceleration measurements. The machine learning model(s) 210 is configured to learn to predict user motion based on the input sequence. Subsequently, an output of the machine learning model(s) 210 is generated. The output may include a predicted device pose focusing solely on the motion of the user while disregarding the motion of the platform. Alternatively, the output may comprise only extracted user motion information. Likewise, an output of the machine learning model(s) 210 may comprise two outputs. A first output may include extracted user motion information and a second output may include extracted platform motion information.

In some implementations, visual odometry may incorporate prior device poses into machine learning model(s) 210. By combining visual odometry providing pose estimation based on visual input with IMU data 201, machine learning model(s) 210 may further enhance its ability to accurately distinguish and predict a device pose(s).

Machine learning model(s) 210 is configured to separate user motion from platform motion by obtaining time series data from an IMU and optional visual inputs, such as prior device poses, to output a predicted device pose while filtering out the motion of the platform. Likewise, training machine learning model(s) 210 with respect to real data collected from moving platforms airplanes, automobiles, elevators, etc. may enable machine learning model(s) 210 to separate and filter relevant motions for improved accuracy and performance.

A process for training machine learning model(s) 210 may include utilizing a loss function to optimize machine learning model(s) 210. For example, a loss function may account for both accuracy and smoothness of the device pose predictions. An accuracy component of the loss function may be enabled to minimize an error between a predicted device pose and a ground truth device pose to bring the predicted device pose to within a specified threshold of the ground truth device pose thereby ensuring high accuracy with respect to capturing user motion. However, only optimizing for accuracy may lead to vibrations or fluctuations associated with the predicted device poses over time. Therefore, a smoothness component may be utilized to penalize excessive variations between consecutive device pose predictions. By incorporating a smoothness penalty, machine learning model(s) 210 is configured to produce predictions that will transition smoothly from one time step to a next time step thereby reducing an overall vibration with respect to the device pose predictions.

The loss function is configured to combine the aforementioned accuracy and smoothness penalties to create a balance between accuracy and stability. During machine learning model(s) 210 training, a network may be configured to minimize the loss function by iteratively adjusting its parameters to improve an accuracy while maintaining smooth transitions between device pose predictions.

In some implementations, each device pose prediction comprises an associated error and all associated errors are summed up or aggregated to calculate an overall loss for a given time step. The optimization process may be configured to evaluate both the error within each time step and the smoothness across multiple time steps to guide training of machine learning model(s) 210. Therefore, the loss function is configured to incorporate accuracy and smoothness penalties to optimize machine learning model(s) 210. The accuracy component is configured to minimize errors between predicted and ground truth poses. Likewise, the smoothness component is configured to promote stable and smooth transitions between consecutive device pose predictions.

In some implementations, a semantic understanding of an environment based on visual data may be used as input to further enhance a decision-making process executed by machine learning model(s) 210. For example, running a separate neural network analyzing visual data and classifying an environment as outdoor or indoor may provide additional data to assist machine learning model(s) 210 to generate more accurate determinations. Likewise, incorporating a semantic understanding of the environment may enable machine learning model(s) 210 to adapt its predictions and behavior accordingly. For example, if the neural network identifies that the user is in an indoor environment, it may adjust its predictions to account for potential obstacles or constraints specific to indoor spaces. Likewise, if the neural network identifies that the user is in an outdoor environment, it may consider factors such as, inter alia, different types of terrain, dynamic external conditions, etc.

In some implementations, Wi-Fi signals may be leveraged as additional input. Wi-Fi signals may provide information about the user's location or proximity to certain points of interest. This information may be used in combination with IMU data 201 and visual data (including pose data 204) to enhance machine learning model's 210 understanding of the context and improve its predictions.

System 200 is further configured to integrate additional sensors, environmental context, and/or signals to further enhance the performance of machine learning model(s) 210 to enable it to adapt to various scenarios and devices.

In some implementations, machine learning model(s) 210 is configured to a determine a specified platform that a user is currently on or within. For example, it may be determined that the user is currently on or within a boat, an airplane, an elevator, a car, etc. The platform enables selection of an appropriate machine learning model that has been trained for that particular platform. It may not be necessary to train all machine learning model across all platforms, as each platform may have its own unique characteristics.

In some implementations, machine learning model(s) 210 is configured to use various types of visual data for device pose predictions. For example, visual odometry as well as alternative forms of visual information, such as images taken in a work-style format, may be used. These alternative forms of visual inputs may comprise a lower resolution or comprise specific information that may be processed efficiently. Therefore, any visual data that is easily and rapidly accessible may be leveraged to improve the performance of system 200.

Further sensors and associated data may be used to assist with determining predicted device poses. For example, sensors such as, inter alia, doppler radar sensors or LIDAR sensors may provide velocity information. Likewise, technologies such as Ultra-Wideband (UWB) or Wi-Fi may assist with localization processes. Therefore, incorporating additional sensors, depending on their capabilities and suitability, may be beneficial for enhancing the overall performance of system 200.

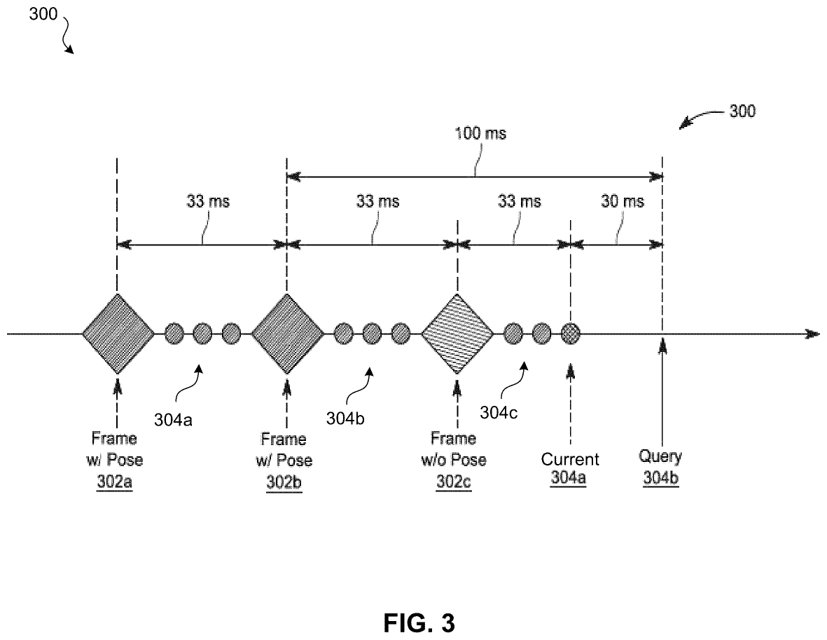

FIG. 3 illustrates a timeline 300 associated with a machine learning-based device pose predictor process, in accordance with some implementations. The machine learning-based device pose predictor process operates at a frequency of at 30 Hz and utilizes frames 302a and 302b comprising previously obtained device poses (i.e., two) to generate a future device pose prediction. Likewise, the machine learning-based pose predictor process is configured to combine information from all past device poses and IMU data 304a-304c, via execution of a learned human and platform motion model, to provide a predicted pose for frame 302c. Some implementations enable velocity and gravity to be implicitly modeled within a neural network to provide an improved accuracy and responsiveness with respect to a device pose prediction.

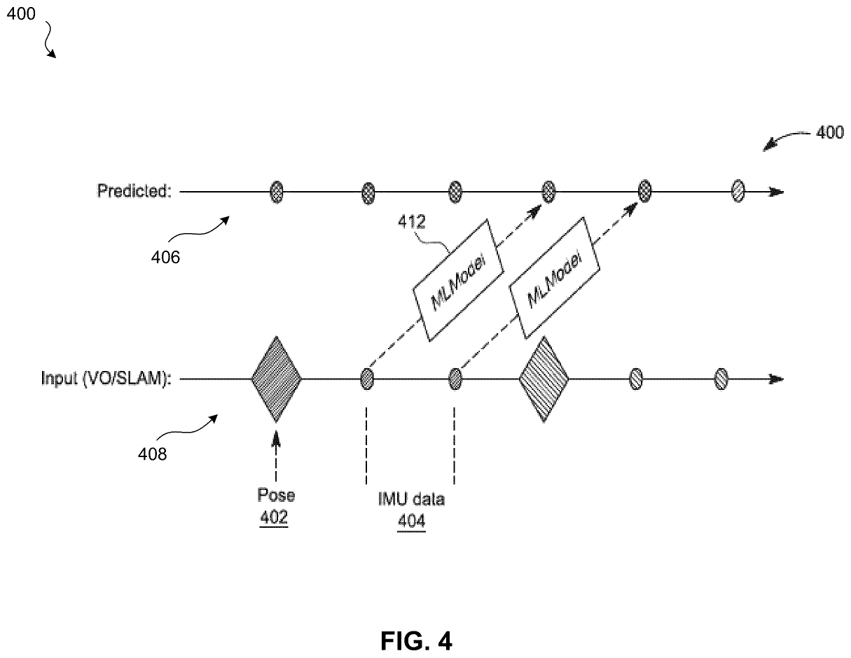

FIG. 4 illustrates a process 400 representing predicted device poses 406 with respect to virtual odometry input 408, in accordance with some implementations. Process 400 executes a machine learning (ML) model 412 (e.g., an LSTM-based RNN) with respect to an input comprising a VO device pose 402 and IMU data 404 to predict 6-DoF future device poses 406.

ML model 412 may be trained to cause a predicted motion capture trajectory to follow a ground truth. A motion capture trajectory represents a recorded path of movement of a human or an object in 3D space over time. Enabling a predicted motion capture trajectory to follow a ground truth with respect to motion capture may include selection and usage of an associated predictive model such as, inter alia, linear regression, neural networks, support vector machines, etc.

Usage of a loss function may further enable a predicted motion capture trajectory to follow a ground truth. For example, prediction term may be used to penalize if a predicted motion capture trajectory deviates from a ground truth trajectory. A prediction term might comprise an output of a neural network associated with predicted position, velocity, or any other relevant information that describes a future trajectory of an object or entity. A smoothness term may be used to penalize ML model 412 if a smoothness profile of the predicted motion capture trajectory differs from a ground truth trajectory. The smoothness term may be added to a loss function during the training of a predictive model. The smoothness term may penalize abrupt changes or oscillations in a motion capture predicted trajectory thereby causing a model to produce smoother and more coherent predictions for preventing bumpy trajectories that may not align with motion patterns of an entity being tracked.

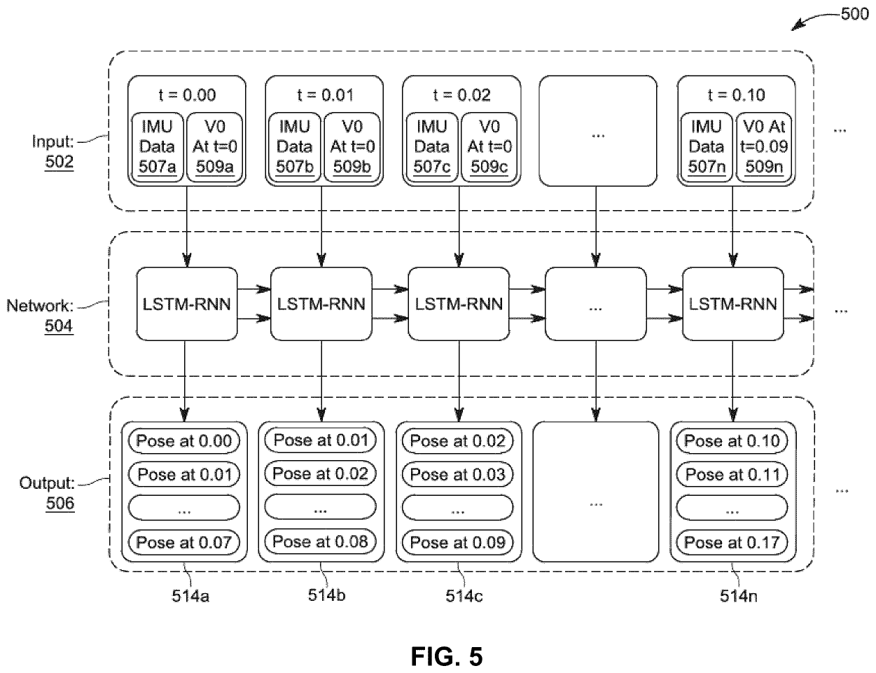

FIG. 5 illustrates a view of a system 500 comprising a recurrent neural network (RNN) 504 configured to analyze input 502 comprising sequential time series data, in accordance with some implementations. Input 502 is processed by RNN 504 to generate an output 506 comprising predicted device poses used for rendering virtual content within a 3D environment based on a viewpoint determined with respect to the predicted future device poses. The sequential time series data comprises IMU data 507a . . . 507n and VO data 509a . . . 509n for input into RNN 504 with respect to differing time steps. For example, at time (t=0.00), IMU data 507a and VO data 509a are inputted into RNN 504 and in response, a predicted device pose 514a is generated as an output. At time (t=0.01), IMU data 507b and VO data 509b are inputted into RNN 504 and in response, a predicted device pose 514b is generated as an output. At time (t=0.02), IMU data 507c and VO data 509c are inputted into RNN 504 and in response, a predicted device pose 514c is generated as an output. At time (t=0.10), IMU data 507n and VO data 509n are inputted into RNN 504 and in response, a predicted device pose 514n is generated as an output.

RNN 504 is trained to extract user motion information from the IMU data 507a . . . 507n and analyze the user motion information to extrapolate into the future thereby providing predicted device poses at the specified time steps. Subsequently, an associated rendering process is enabled to utilize the predicted device poses to accurately render virtual content within a 3D environment based on the predicted device poses.

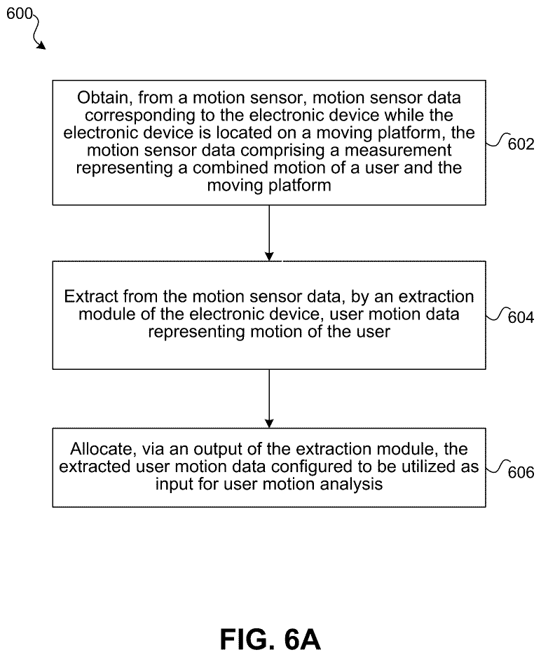

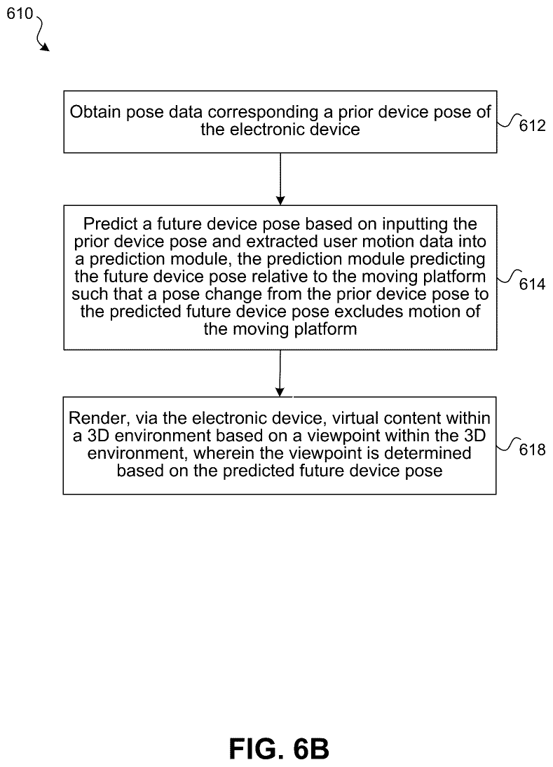

FIG. 6A is a flowchart representation of an exemplary method 600 that separates human motion from platform motion, in accordance with some implementations. In some implementations, the method 600 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains, from a motion sensor, motion sensor data corresponding to an electronic device while the electronic device is located on a moving platform. The motion sensor may be, inter alia, an inertial measurement unit (IMU) sensor obtaining IMU data such as IMU data 201 as illustrated in FIG. 2. The motion sensor data may include a measurement representing a combined motion of a user and the moving platform. In some implementations the user may be holding the electronic device (e.g., a mobile device) during the combined motion. In some implementations the user may wear the electronic device (e.g., an HMD) during the combined motion. The motion sensor data may include data associated with angular velocity, gravity direction, and IMU bias with respect to the combined motion. The moving platform may comprise a moving object that includes a structure surrounding a user holding or wearing the electronic device. For example, the moving platform may be an aircraft, an elevator, etc.

At block 604, the method 600 extracts, from the motion sensor data via an extraction module (e.g., an extraction module associated with the machine learning model(s) 210 illustrated in FIG. 2) of the electronic device, user motion data representing motion of the user without including motion of the moving platform.

At block 606, the method 600 allocates, via an output of the prediction module, the extracted user motion data configured to be utilized as input for user motion analysis as described in accordance with some implementations with respect to the optional method 610 of FIG. 6B, infra.

FIG. 6B is a flowchart representation of an exemplary method 610 utilizing the extracted user motion data of the method of FIG. 6A to render content within an XR environment via an electronic device being operated by a user on a moving platform, in accordance with some implementations. In some implementations, the method 610 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 610 is performed by processing logic, including hardware, firmware, software, or a combination thereof. In some implementations, the method 610 is performed by a processor executing code stored in a non-transitory computer-readable medium (e.g., a memory). Each of the blocks in the method 610 may be enabled and executed in any order.

At block 612, the method 610 obtains pose data corresponding a prior device pose of the electronic device. The pose data may comprise data such as pose data 204 as described with respect to FIG. 2. The prior device pose may include a plurality of prior device poses.

At block 614, the method 610 predicts a future device pose based on inputting the prior device pose and extracted user motion data (extracted and outputted via steps 604 and 606 of the method 600 of FIG. 6A as described, supra) into a prediction module such as a prediction module associated with the machine learning model(s) 210 illustrated in FIG. 2. The prediction module is configured to predict the future device pose relative to the moving platform such that a pose change from the prior device pose to the predicted future device pose excludes motion of the moving platform as described with respect to operation of machine learning model(s) 210 in FIG. 2. The pose change corresponds to only body motion of a user holding or wearing the electronic device. The predicted future device pose may comprise a six degrees of freedom (6-DOF) position corresponding to motion of a user holding or wearing the electronic device. The predicted future device pose may include a prediction with respect to specified timeframe into the future.

At block 618, the method 610 may further obtain, from a sensor, location-based sensor data corresponding to conditions of an environment traversed by the moving platform such that predicting the future device pose is further based on inputting the location-based sensor data into the prediction module. The sensor may include a location detection sensor such as a laser, a cell-based sensor, Wi-Fi sensors for global positioning information, etc.

At block 618, the method 610 may further optimize the prediction module. The prediction module may be optimized by minimizing an error between the predicted future device pose and a ground truth pose. Alternatively, the prediction module may be optimized by providing smooth transitions between the predicted future device pose and additional consecutive predicted future device poses.

At block 618, the method 610 renders, via the electronic device, virtual content within a 3D environment based on a viewpoint within the 3D environment. The viewpoint may be determined based on the predicted future device pose.

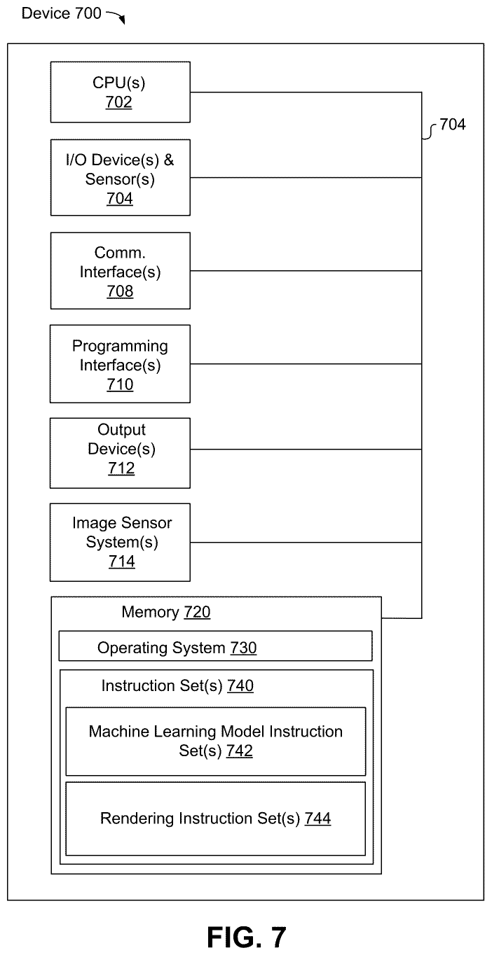

FIG. 7 is a block diagram of an example device 700. Device 700 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUS, CPUs, processing cores, and/or the like), one or more input/output (I/O) devices and sensors 704, one or more communication interfaces 708 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a machine learning model instruction set 742 and a rendering instruction set 744. The instruction set(s) 740 may be embodied as a single software executable or multiple software executables.

The machine learning model instruction set 742 is configured with instructions executable by a processor to predict a future device pose based on inputting a prior device pose and motion sensor data into a machine learning model to predict the future device pose relative to the moving platform such that a pose change from the prior device pose to the predicted future device pose excludes motion of the moving platform.

The rendering instruction set 744 is configured with instructions executable by a processor to render virtual content within a 3D environment based on a viewpoint within the 3D environment.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor, a motion sensor, and a display:
obtaining, from the motion sensor, motion sensor data corresponding to the electronic device while the electronic device is located on a moving platform, the motion sensor data comprising a measurement representing a combined motion of a user and the moving platform;
extracting from the motion sensor data, by an extraction module of the electronic device, user motion data representing motion of the user; and
allocating, via an output of the extraction module, the extracted user motion data as input for user motion analysis.

2. The method of claim 1, further comprising:
obtaining pose data corresponding a prior device pose of the electronic device;
predicting a future device pose based on inputting the prior device pose and the extracted user motion data into a prediction module, the prediction module predicting the future device pose relative to the moving platform such that a pose change from the prior device pose to the predicted future device pose excludes motion of the moving platform; and
rendering, via the electronic device, virtual content within a 3D environment based on a viewpoint within the 3D environment, wherein the viewpoint is determined based on the predicted future device pose.

3. The method of claim 2, wherein the pose change corresponds to body motion of the user.

4. The method of claim 2, wherein the motion sensor is an inertial measurement unit (IMU) sensor.

5. The method of claim 4, wherein the motion sensor data comprises data associated with angular velocity, gravity direction, and IMU bias with respect to the combined motion.

6. The method of claim 2, wherein the predicted future device pose comprises a six degrees of freedom (6-DOF) pose corresponding to the motion of the user.

7. The method of claim 2, wherein the prior device pose includes a plurality of prior device poses.

8. The method of claim 2, wherein the predicted future device pose comprises a prediction with respect to specified timeframe into the future.

9. The method of claim 2, further comprising:
obtaining, from a sensor, location-based sensor data corresponding to conditions of an environment traversed by the moving platform, wherein said predicting the future device pose is further based on inputting the location-based sensor data into the prediction module.

10. The method of claim 2, further comprising:
optimizing the prediction module by minimizing an error between the predicted future device pose and a ground truth pose.

11. The method of claim 2, further comprising:
optimizing the prediction module by providing smooth transitions between the predicted future device pose and additional consecutive predicted future device poses.

12. The method of claim 1, wherein the moving platform is a moving object comprising a structure surrounding the user and the electronic device.

13. An electronic device comprising:
a non-transitory computer-readable storage medium;
a motion sensor; and
one or more processors coupled to the non-transitory computer-readable storage medium, wherein the non-transitory computer-readable storage medium comprises program instructions that, when executed on the one or more processors, cause the electronic device to perform operations comprising:
obtaining, from the motion sensor, motion sensor data corresponding to the electronic device while the electronic device is located on a moving platform, the motion sensor data comprising a measurement representing a combined motion of a user and the moving platform;
extracting from the motion sensor data, by an extraction module of the electronic device, user motion data representing motion of the user; and
allocating, via an output of the extraction module, the extracted user motion data as input for user motion analysis.

14. The electronic device of claim 13, wherein the program instructions, when executed on the one or more processors, further cause the electronic device to perform operations comprising:
obtaining pose data corresponding a prior device pose of the electronic device;
predicting a future device pose based on inputting the prior device pose and the extracted user motion data into a prediction module, the prediction module predicting the future device pose relative to the moving platform such that a pose change from the prior device pose to the predicted future device pose excludes motion of the moving platform; and
rendering, via the electronic device, virtual content within a 3D environment based on a viewpoint within the 3D environment, wherein the viewpoint is determined based on the predicted future device pose.

15. The electronic device of claim 14, wherein the pose change corresponds to body motion of the user.

16. The electronic device of claim 14, wherein the motion sensor is an inertial measurement unit (IMU) sensor.

17. The electronic device of claim 16, wherein the motion sensor data comprises data associated with angular velocity, gravity direction, and IMU bias with respect to the combined motion.

18. The electronic device of claim 14, wherein the predicted future device pose comprises a six degrees of freedom (6-DOF) pose corresponding to the motion of the user.

19. The electronic device of claim 14, wherein the prior device pose includes a plurality of prior device poses.

20. A non-transitory computer-readable storage medium storing program instructions executable via one or more processors, of an electronic device comprising a motion sensor, to perform operations comprising:
obtaining, from the motion sensor, motion sensor data corresponding to the electronic device while the electronic device is located on a moving platform, the motion sensor data comprising a measurement representing a combined motion of a user and the moving platform;
extracting from the motion sensor data, by an extraction module of the electronic device, user motion data representing motion of the user; and
allocating, via an output of the extraction module, the extracted user motion data as input for user motion analysis.
